(19) United States
(12) Patent Application Publication
(10) Pub. No.: US 2002/0101746 A1
(43) Pub. Date: Aug. 1, 2002

(54) Voltage converter for several independent loads

(76) Inventor: Christoph Loef, Aachen (DE)

Correspondence Address: U.S. Philips Corporation, 580 White Plains Road, Tarrytown, NY, 10591, US

(21) Appl. No.: 10/020,052

(22) Filed: Dec. 7, 2001

(30) Foreign Application Priority Data
Dec. 9, 2000 (DE) 10061385.3

(51) Int. Cl. H02M 1/00

(52) U.S. Cl. 363/71

(57) ABSTRACT

The invention relates to a voltage converter for two independent loads (L1, L2) with a bridge circuit (S₁, S₂, Sₐ, S_{b} and S₃, S₄, Sₐ, S_{b}) for a first (L1) and a second (L2) load, respectively, for converting a DC voltage (U₄₅) jointly applied to the bridge circuits (S₁, S₂, Sₐ, S_{b} and S₃, S₄, Sₐ, S_{b}) into an AC voltage (U₆₈, U₉₈) assigned to the respective load (L1, L2),

wherein two switching elements (Sₐ, S_{b}) are common to the bridge circuits (S₁, S₂, Sₐ, S_{b} and S₃, S₄, Sₐ, S_{b}).

The invention relates to a voltage converter for several independent loads. Such voltage converters serve to convert a voltage applied to their inputs into supply voltages which are controllable independently of one another for the connected loads. They may be used, for example, as switch mode power supplies for the conversion of an AC voltage into several DC voltages in a TV set with flat screen.

A voltage converter which loads a public AC mains is subject to particular requirements as regards the current which is allowed to be drawn from the AC mains. Thus the current taken up by the voltage converter is usually allowed to comprise only a limited proportion of harmonics, i.e. the voltage converter must constitute an actual resistance in principle. The apparent resistance portion of the input impedance of the voltage converter must not exceed certain values accordingly. Such requirements are specified in more detail, for example, in IEC 1000-3-2.

A voltage converter with a resonance converter is known from DE 198 24 409 A1 which connects an upconverter consisting purely of passive components directly to the output of a half bridge. The publication by W. Chen, F. C. Lee, and T. Yamauchi “An improved ‘Charge Pump’ electronic ballast with low THD and low crest factor”, IEEE APEC '96 Proceedings, pp. 622-627, contains further realization possibilities for such an arrangement. On the other hand, J. Wüstehube, Schaltnetzteile (Switch Mode Power Supplies), second revised edition, p. 139 ff. describes a bridge rectifier circuit with a conversion device by means of which the bridge rectifier circuit is adapted to the respective applied AC mains voltage (110-127V, for example, in the USA, or 220-240V, for example, in Europe), such that the generated DC voltage has approximately equal values independently of the applied AC mains voltage.

It is an object of the invention to provide a voltage converter which is as inexpensive as possible and which is capable of supplying several output voltages which are controllable independently of one another. Furthermore, the current drawn from an AC mains by the voltage converter must comprise only a limited amount of harmonics and must represent substantially an actual resistance.

This object is achieved by means of a voltage converter as claimed in claim 1. A bridge circuit consisting of four switching elements is associated with a load which requires a supply voltage which is controllable independently of those of the other loads. Two switching elements of the bridge circuits are shared in this case, whereby a saving is made in the number of components.

In claim 2, a resonance converter with a resonant series-parallel resonant circuit is used in the voltage converter for a load. This renders it possible in conjunction with a suitable control of the switching elements of the bridge circuit associated with the load to achieve a wider conversion range for the conversion of the input voltage into the output voltage designed for this load. Such resonant series-parallel oscillation circuits are known, for example from the publication “V. B. Beaguli, A. K. S. Bhat: Operation of the LCC-Type Parallel Resonant Converter as a Low Harmonic Rectifier. IEEE APEC, 1996, pp. 131-137”.

Claim 3 provides two modes for the operation of the bridge circuits of the voltage converter. This renders possible, for example, the use of the voltage converter on different AC mains voltages of different AC mains networks in that the ratios of the output voltages to the voltage applied to the input of the voltage converter can be adjusted. This adjustment possibility reduces the requirements imposed on the control circuit and renders it possible to use the same components for the voltage converter which are provided for the operation on different input voltages or for different output voltages. This leads to a considerable saving in cost of the voltage converter.

The dependent claims 4 to 7 relate to modifications of the invention which have a favorable influence on the mains load caused by the voltage converter, on the practical applicability of the voltage converter, or on the constructional cost of the voltage converter.

In claim 8, however, the invention also relates to an integrated circuit which integrates the control circuit necessary for operating the bridge circuits in one component. Furthermore, the switching elements of the bridge circuits may also be integrated. A further reduction in manufacturing cost can be achieved by such integrations.

A further aspect of the invention is that a voltage converter according to the invention is particularly suitable for monitors and for TV sets, for example with flat screens. These appliances require accurately controlled and smoothed current supplies.

These and further aspects and advantages of the invention will be explained in more detail below with reference to the embodiments and in particular with reference to the appended drawings, in which:

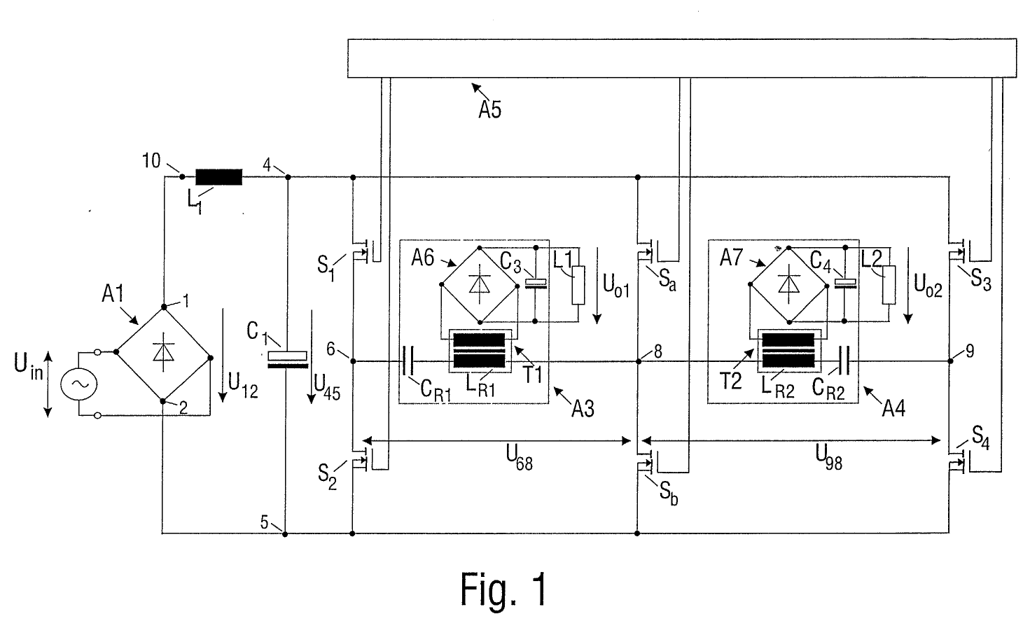

FIG. 1 shows an embodiment of the voltage converter according to the invention,

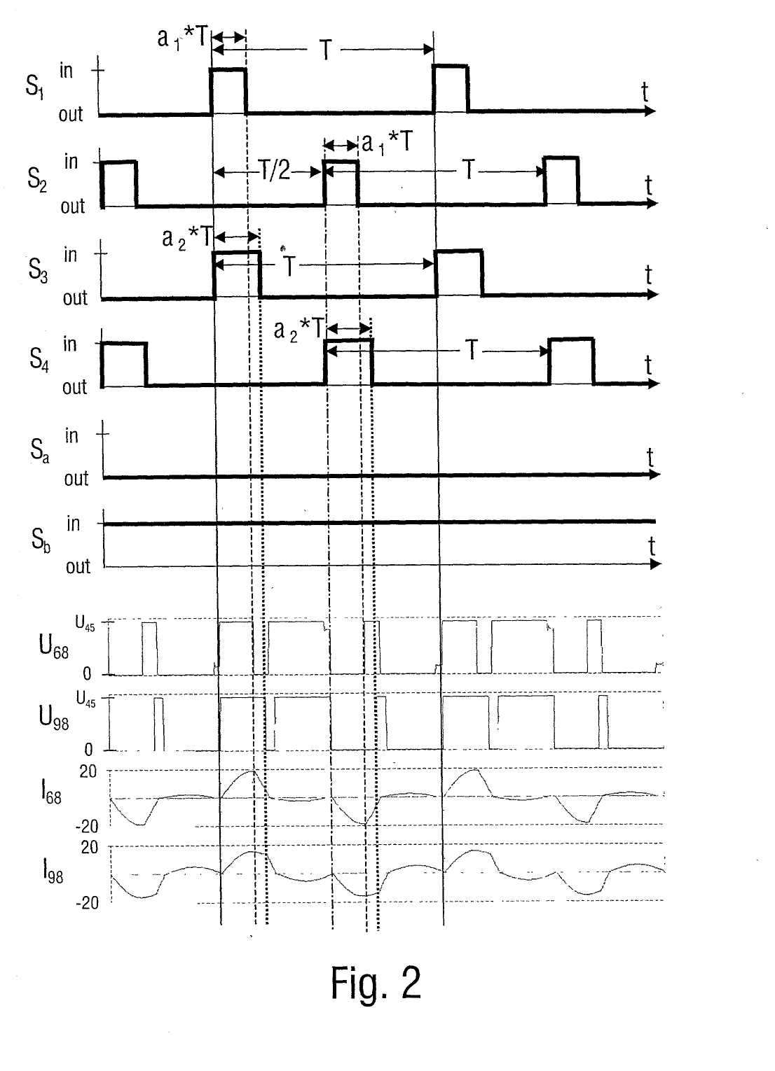

FIG. 2 shows gradients relating to the switching states, the voltage, and the current by way of clarification of the operation of the bridge circuits as half bridge circuits,

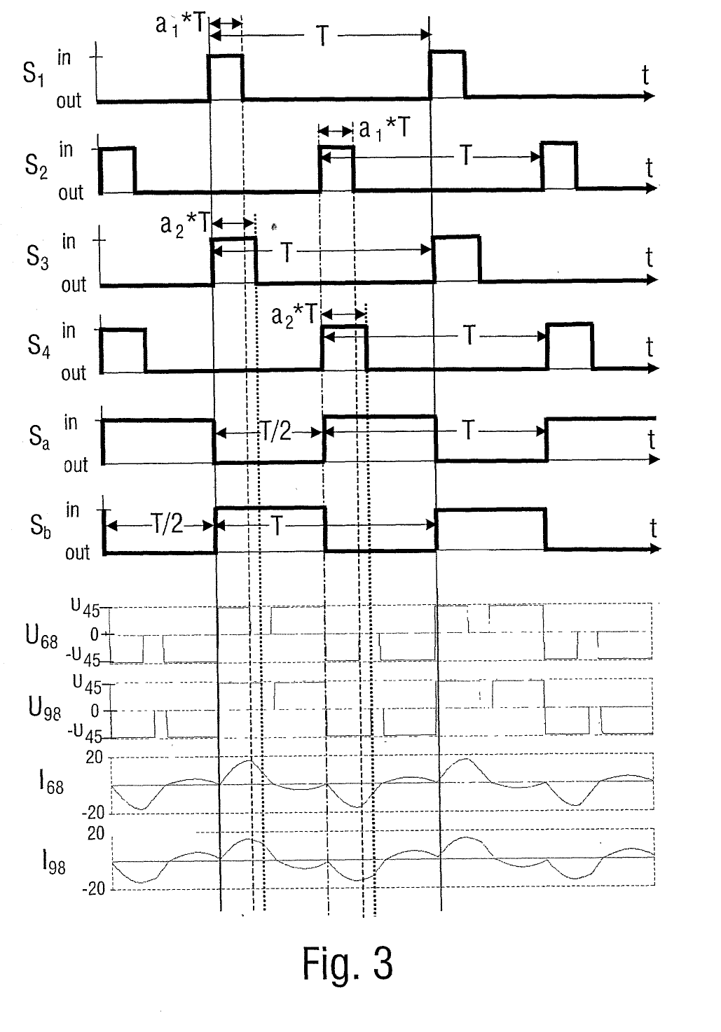

FIG. 3 shows gradients relating to the switching states, the voltage, and the current by way of clarification of the operation of the bridge circuits as full bridge circuits,

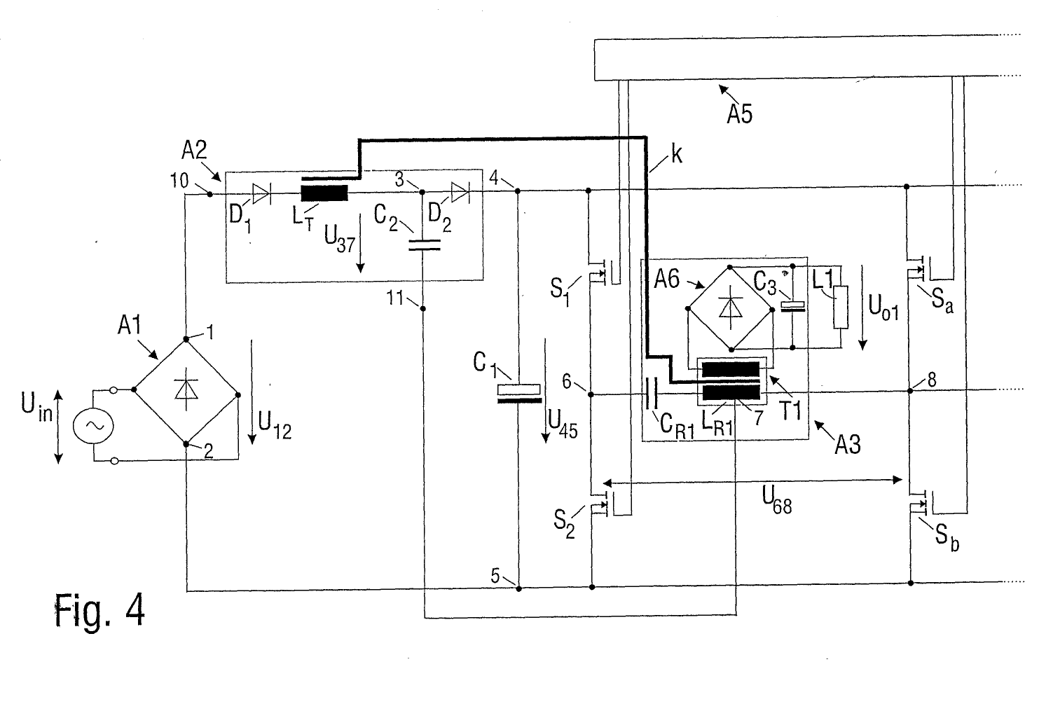

FIG. 4 shows a modification of the voltage converter according to the invention with an arrangement operating as an upconverter, and

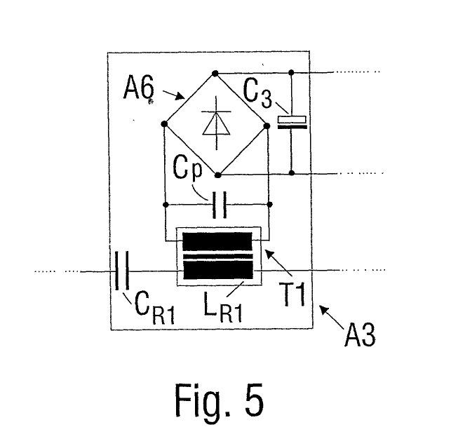

FIG. 5 shows a resonance converter with a resonant series-parallel oscillation circuit.

FIG. 1 shows an embodiment of the voltage converter according to the invention. A first AC voltage Uᵢₙ is supplied to the input of the voltage converter, which voltage is converted into a rectified AC voltage U₁₂ with the positive pole in point 1 and the negative pole in point 2 by a first rectifier device A1 consisting of four diodes. The first AC voltage Uᵢₙ is, for example, a sinusoidal 230V mains voltage with a frequency of 50 Hz.

The rectified AC voltage U₁₂ is supplied to a smoothing arrangement, here consisting of the series circuit of an inductance L₁ with a first smoothing capacitor arrangement C₁, constructed as an electrolytic capacitor in this case. The point 1 of the first rectifier arrangement A1 is coupled here to the inductance L₁ in a point 10, which inductance in its turn is joined to the positive side of the smoothing capacitor arrangement C₁ in a point 4. The negative side of the smoothing capacitor arrangement C₁, finally, is connected to the point 2 of the first rectifier arrangement A1 in a junction point 5. Similarly, U₄₅ denotes the smoothed, rectified AC voltage applied to the first smoothing capacitor arrangement C₁ between the points 4 and 5.

The smoothed, rectified AC voltage U₄₅ is supplied to two bridge circuits. The two bridge circuits each consist of four switching elements, i.e. the switching elements S₁, S₂, Sₐ, S_{b} and S₃, S₄, Sₐ, S_{b}, i.e. the two switching elements Sₐ, S_{b} are common to the two bridge circuits. The switching elements are constructed as field effect transistors here. Instead, however, alternative constructions may be used for the switches such as, for example, IGBTs (Insulated Gate Bipolar Transistors). The switching elements S₁ and S₂, S₃ and S₄, and Sₐ and S_{b} form series circuits situated in parallel to one another to which the voltage U₄₅ is jointly applied.

A first further AC voltage U₆₈ arises between a point 6 situated between the switching elements S₁ and S₂ and a point 8 situated between the switching elements Sₐ and S_{b} from the rectified and smoothed AC voltage U₄₅ through a suitable switching-on and -off of the switching elements S₁, S₂, Sₐ, S_{b}. Similarly, a second further AC voltage U₉₈ arises between a point 9 situated between the switching elements S₃ and S₄ and the point 8 situated between the switching elements Sₐ and S_{b} from the rectified and smoothed AC voltage U₄₅ through a suitable switching-on and -off of the switching elements S₃, S₄, Sₐ, S_{b}. These further AC voltages U₆₈, U₉₈ are subsequently converted into the output DC voltages Uₒ₁, Uₒ₂ which are available to the two loads L1 and L2. The two further AC voltages U₆₈, U₉₈ are AC voltages associated with the respective loads L1, L2 in this sense.

The AC voltage U₆₈ associated with the load L1 is supplied to the input of a resonance converter A3 at whose output, which is at the same time the first output of the voltage converter, a first output DC voltage Uₒ₁ arises which serves to supply a first load L1. Similarly, the AC voltage U₉₈ associated with the load L2 is supplied to the input of a resonance converter A4, at whose output, which is at the same time the second output of the voltage converter, a second output DC voltage Uₒ₂ arises which serves to supply a second load L2. The loads L1, L2 represented as ohmic loads here may in general also be of an inductive, capacitive, or mixed nature.

The resonance converters A3 and A4 are of the same construction and serve the same functions. They each comprise resonance circuit elements: a resonance capacitor C_{R1} and C_{R2} and a transformer T1 and T2 acting inter alia as a resonance inductance L_{R1} and L_{R2}, respectively, ensuring a potential separation between the input and output of the respective resonance converter A3, A4. The resonance capacitor C_{R1}, C_{R2} and the primary winding of the transformer T1, T2 are connected in series between the points 6 and 8, and between 9 and 8, respectively, thus forming the input sides of the relevant resonance converters A3, A4. One side of each resonance capacitor C_{R1}, C_{R2} is connected to the point 6, 9, respectively. The AC voltage arising at the secondary side of the respective transformer T1, T2 is rectified by means of a second and third rectifier arrangement A6, A7 consisting of four diodes, and is subsequently smoothed by means of a second and third smoothing capacitor arrangement C₃, C₄, here consisting each of a smoothing capacitor. The output voltage of the capacitor arrangement C₃, C₄ is the output DC voltage Uₒ₁, Uₒ₂ present at the respective output of the voltage converter.

The switching elements S₁, S₂, Sₐ, S_{b}, S₃, S₄, are coupled to a control circuit A5 which controls the switching elements through the application of suitable control signals to the control inputs of the switching elements, i.e. switches them on (puts them into the conductive state) or switches them off (puts them in the non-conductive state). The control circuit A5 is preferably realized in the form of an integrated circuit (IC) which may possibly also include said six switching elements S₁, S₂, Sₐ, S_{b}, S₃, S₄. The control circuit A5 controls the switching elements S₁, S₂, Sₐ, S_{b}, S₃, S₄ of the bridge circuits S₁, S₂, Sₐ, S_{b} and S₃, S₄, Sₐ, S_{b} in two different modes here, which achieve different values for the ratios Uₒ₁/U₆₈ and Uₒ₂/U₉₈, and thus also different values of the ratios Uₒ₁/Uᵢₙ and Uₒ₂/Uᵢₙ.

It is thus possible, for example, to achieve an adaptation to the mains AC voltage applied to the input of the voltage converter through a change in the mode. Particularly advantageous here is the change in the ratios Uₒ₁/Uᵢₙ, Uₒ₂/Uᵢₙ by approximately a factor 2, because, for example, the mains AC voltages used in Europe (approximately 220 to 240 V) and in the USA (approximately 110 to 127 V) differ by approximately a factor 2.

Such an adaptation to the mains AC voltage applied to the input of the voltage converter may be carried out automatically, for example by the control circuit A5. For this purpose, the control circuit A5 is constructed such that the voltage converter is prepared for operation on two mains AC voltages Uᵢₙ of different values. To enable the control circuit A5 to ascertain which of the two envisaged mains AC voltages Uᵢₙ is instantaneously being applied to the voltage converter during operation, the rectified and smoothed AC voltage U₄₅ or alternatively the mains AC voltage Uᵢₙ itself may be supplied to the control circuit A5 for measurement, for example. The control circuit A5 then switches to the second mode in the case of the lower of the two envisaged mains AC voltages, whereas it switches to the first mode in the case of the higher of the two envisaged mains AC voltages so as to achieve the automatic adaptation to the two envisaged mains AC voltages.

In the first mode, the control circuit A5 controls the switching elements S₁, S₂, Sₐ, S_{b}, S₃, S₄ in a manner such that the bridge circuits S₁, S₂, Sₐ, S_{b} and S₃, S₄, Sₐ, S_{b} are operated as half bridge circuits. For this purpose, one of the two switching elements, Sₐ or S_{b}, is continuously off while the other one is continuously on, i.e., for example, Sₐ is continuously switched off and S_{b} is continuously switched on. The two other switching elements, S₁ and S₂, or S₃ and S₄, are switched on and off in suitable duty cycles, during which they are never switched on simultaneously so as to prevent short-circuits. This half bridge operation causes the rectified and smoothed AC voltage U₄₅ to be applied to the input of the resonance converter A3 or A4 as the first or second further AC voltage U₆₈ or U₉₈ during the conductive period of the switch S₁ or S₃, respectively, whereas in the conductive phase of the switch S₂ or S₄ the further AC voltages U₆₈ or U₉₈ drop to the ideal short-circuit value of 0V.

In the second mode, the control circuit A5 controls the switching elements S₁, S₂, Sₐ, S_{b}, S₃, S₄ in a manner such that the bridge circuits S₁, S₂, Sₐ, S_{b} and S₃, S₄, Sₐ, S_{b} are operated as full bridge circuits. For this purpose, the switching elements S₁, S₂, Sₐ, S_{b}, S₃, S₄ are switched on and off in pairs in suitable duty cycles while avoiding a short-circuit, i.e. the switches two by two: S₁ and S_{b}, S₂ and Sₐ, S₃ and S_{b}, S₄ and Sₐ form pairs in the sense that the on-phases of S₁ and S₃ lie within the on-phase of S_{b}, and the on-phases of S₂ and S₄ lie within the on-phase of Sₐ, while the switches S₁ and S₂, Sₐ and S_{b}, and S₃ and S₄, respectively, are never switched on simultaneously for the prevention of short-circuits. Owing to this full bridge operation, the rectified and smoothed AC voltage U₄₅ is applied as the first or second further AC voltage U₆₈, U₉₈ to the input of the respective resonance converter A3, A4 during the conductive phase of the switches S₁ and S₃, whereas the negative rectified and smoothed AC voltage U₄₅ is applied during the conductive phase of the switches S₂ and S₄.

Whereas in the half bridge operation of the first mode the short-circuit voltage of ideally 0V is applied to the input of the respective resonance converter A3, A4 in the conductive phase of the switches S₂ and S₄, the negative rectified and smoothed Ac voltage U₄₅ is applied in the full bridge operation in accordance with the second mode. This results in an increase in the ratios Uₒ₁/Uᵢₙ and Uₒ₂/Uᵢₙ, all other quantities of the circuit remaining the same. Alternatively, a so-called “Phase-Shifted PWM Full-Bridge” control of the switching elements of the bridge circuits S₁, S₂, Sₐ, S_{b} and S₃, S₄, Sₐ, S_{b} may be chosen for the second mode, as described in DE 198 24 409 A1 and the publication cited therein “Unitrode Power Supply Seminar, SEM-800, Bob Mammano and Jeff Putsch: Fixed-Frequency, Resonant-Switched Pulse Width Modulation with Phase-Shifted Control, September 91, pp. 5-1 to 5-7 (in particular FIG. 1)”.

In both modes, the control circuit A5 may also carry out an adaptation of the switching frequencies and the duty cycles of the switching elements S₁, S₂, Sₐ, S_{b}, S₃, S₄. With the use of the “Phase-Shifted PWM Full-Bridge” control, furthermore, an adaptation of the value of the phase shifts between the switching moments of the switch pairs S₁ and S_{b}, S₂ and Sₐ, S₃ and S_{b}, S₄ and Sₐ can be carried out. These adaptations may be carried out independently of one another for the non-shared pairs of switches S₁, S₂ and S₃, S₄ of the bridge circuits S₁, S₂, Sₐ, S_{b} and S₃, S₄, Sₐ, S_{b}. As a result of this, the values and stabilities of the further AC voltages U₆₈ and U₉₈ supplied by the voltage converter can be adjusted independently of one another, and thus also the values and stabilities of the output DC voltages Uₒ₁ and Uₒ₂ supplied by the voltage converter.

FIGS. 2 and 3 show examples of gradients representing switching states, voltages, and currents for the half and full bridge operations by way of a further explanation of the operation of the bridge circuits S₁, S₂, Sₐ, S_{b} and S₃, S₄, Sₐ, S_{b}. Time is plotted to the right in all diagrams in the Figures, while the switching states, voltages, and currents are plotted on the vertical axis. The time axes of all sub-diagrams run in synchronity. The sub-diagrams of the two Figures show the following switching states, voltages, and currents, from top to bottom:

the switching states of the switches S₁, S₂, S₃, S₄, Sₐ, S_{b},

the voltage U₆₈ present across the resonance converter A3 between the points 6 and 8,

the voltage U₉₈ present across the resonance converter A4 between the points 9 and 8,

the current I₆₈ flowing from point 6 to point 8 through the input side of the resonance converter A3, and

the current I₉₈ flowing from point 9 to point 8 through the input side of the resonance converter A4.

All voltages shown move between 0V and the positive or negative value of the rectified and smoothed AC voltage U₄₅, while the currents are plotted in arbitrary units. In this example, the switches S₁, S₂, S₃, S₄, Sₐ, S_{b} are operated with a uniform switching frequency having the cycle duration T. The duty cycles of the switches S₁ and S₂ are uniformly a₁, i.e. the two switches are switched on in a cycle duration T during a period of a₁*T, and are otherwise switched off. The duty cycles of the switches S₃ and S₄ are uniformly a₂. The switches S₁ and S₃ are switched on simultaneously, whereas the switch-on moments of the switches S₂ and S₄ are shifted with respect to those of the switches S₁ and S₃ by half a cycle T/2 in time.

In the half bridge operation of the first mode shown in FIG. 2, the switch Sₐ is continuously switched off and the switch S_{b} continuously switched on. In the full bridge operation of the second mode shown in FIG. 3, by contrast, the switches Sₐ and S_{b} are switched on and off in alternation, each with a duty cycle of ½. This means that when Sₐ is switched on, S_{b} is switched off, and vice versa. The switch-on moment of S_{b} is the same as that of S₁ and S₃, while that of Sₐ is identical to that of S₂ and S₄. It should be noted for a better understanding of the voltage and current gradient resulting from these switching ratios, as shown in the lower sub-diagrams of FIGS. 2 and 3, that the switches S₁, S₂, S₃, S₄, Sₐ, S_{b} were constructed as field effect transistors (FETs) in this case whose construction implies that a diode is connected in parallel to the switch proper. A directional dependence is accordingly to be taken into account in the incorporation of the FETs. For example, the diode of the switch S₁ is conducting from point 6 to point 4.

To achieve a homogeneous load on the mains of the voltage converter, it is suggested in a further embodiment of the invention to operate the switches S₁, S₂, S₃, S₄, Sₐ, S_{b} with variable switching frequencies and/or duty cycles. A suitable adaptation of the switching frequencies and/or duty cycles by the control circuit A5 will then render it possible to achieve a homogeneous power consumption from the mains. It is particularly advantageous here to modulate the switching frequencies and/or duty cycles of the switches S₁, S₂, S₃, S₄, Sₐ, S_{b} with double the frequency of the first AC voltage Uᵢₙ applied to the input of the voltage converter, i.e. to choose for these switching frequencies and/or duty cycles a periodic time sequence whose frequency is equal to double the frequency of Uᵢₙ . In particular, the switches S₁, S₂, S₃, S₄, Sₐ, S_{b} may also be operated with uniformly constant or variable switching frequency.

FIG. 4 shows a modification of the voltage converter according to the invention with an arrangement A2 operating as an upconverter. This arrangement A2 comprises first a series circuit of a first diode D₁, an inductance L_{T}, and a second diode D₂. This series circuit replaces the inductance L₁ of the embodiment of the voltage converter described with reference to FIG. 1, i.e. the series circuit is connected instead of the inductance L₁ by its diode D₁ in point 10 to point 1 of the first rectifier arrangement A1, and by its diode D₂ in point 4 to the first capacitor arrangement C₁. Furthermore, the arrangement A2 acting as an upconverter also comprises a coupling capacitor C₂. This is coupled at one side to a junction point 3 between the inductance L_{T} and the diode D₂, and at the other side by a point 11 to a point 7 inside one of the resonance converters, A3 in this case. This point 7 inside the resonance converter A3 is realized by portions of the primary winding of the transformer T1 and a tap to the junction point 7. In addition, the inductance L_{T} is magnetically coupled to the resonance inductance L_{R1} of the resonance converter A3 via a coupling k.

A potential U₃₇ modulated with the operating frequency of the resonance converter A3 is fed back to the point 3 within the arrangement A2 acting as an upconverter during operation of the voltage converter owing to this capacitive and inductive coupling via the coupling capacitor C₂ and the magnetic coupling k of the inductance L_{T}. Since the diode D₂ conducts the current only in the direction from point 3 to point 4, this feedback results in an upconversion of the smoothed rectified AC voltage U₄₅ which is available at the first smoothing capacitor arrangement C₁. The diode D₁ prevents a return current to the input of the voltage converter.

The embodiment of the arrangement A2 acting as an upconverter as shown here and its couplings to one of the resonance converters is only one out of several possibilities. Thus, for example, the diode D₁ and the inductance L_{T} may be left out individually or together. For further explanations and possibilities of the operating principle of the arrangement A2 acting as an upconverter the reader is referred to DE 198 24 409 A1. Further possibilities for realizing the junction point 7 are also represented therein, all achieving the purpose of feeding back a potential U₃₇ modulated with the operating frequency of the resonance converter A3 to the point 3. Those skilled in the art may readily identify further modifications.

Whereas FIG. 4 shows only an arrangement A2 acting as an upconverter which is coupled capacitively and inductively to the resonance converter A3, this principle may also be given a multiple application. For this purpose, the series circuits of, for example, a respective first diode D₁, an inductance L_{T}, and a second diode D₂ of the arrangements acting as upconverters are to be connected in parallel to one another between the points 10 and 4, while their capacitive and inductive couplings are achieved by analogy to those shown in FIG. 4, i.e. each respective coupling capacitor C₂ is connected to a respective point 7 in the respective resonance converter A3, A4 in a respective junction point 11. Similarly, each inductance L_{T} is magnetically coupled via the respective coupling k to the respective resonance inductance L_{R1}, L_{R2} of the associated resonance converter A3, A4.

It is particularly advantageous to couple the resonance converters A3, A4, which supply a load with a high power requirement, to a respective arrangement A2 acting as an upconverter. This is because these resonance converters A3, A4 lead to a high mains load. Since they are usually operated in the vicinity of their respective resonance frequencies, their coupling to a respective arrangement A2 acting as an upconverter leads to a particularly effective upconversion of the smoothed rectified AC voltage U₄₅. This accordingly leads to a particularly advantageous countermeasure against the uneven load on the mains.

FIG. 5 shows a modification of one of the resonance converters according to the invention, A3 in this case, with a resonant series-parallel oscillation circuit. In contrast to the resonance converters A3 and A4 described with reference to FIG. 1, the modification of FIG. 5 has an additional capacitor Cₚ which is connected in parallel to the secondary winding of the transformer T1. The resonance converter A3 is thus made into a series-parallel oscillation circuit such as is known, for example, from the publication “V. B. Beaguli, A. K. S. Bhat: Operation of the LCC-Type Parallel Resonant Converter as a Low Harmonic Rectifier. IEEE APEC, 1996, pp. 131-137”.

Where the invention was described above as a voltage converter for exactly two independent loads L1, L2, it will be obvious to those skilled in the art that the principle of the invention, the use of two switching elements Sₐ, S_{b} jointly in the bridge circuits, can be expanded to more than two loads. Voltage converters for more than two loads can accordingly also be constructed with the use of the principle of the invention, wherein bridge circuits utilize all switching elements or alternatively only two switching elements Sₐ, S_{b} jointly.

1. A voltage converter for two independent loads (L1, L2) with a respective bridge circuit (S₁, S₂, Sₐ, S_{b} and S₃, S₄, Sₐ, S_{b}) for a first (L1) and a second (L2) load for converting a DC voltage (U₄₅) jointly applied to the bridge circuits (S₁, S₂, Sₐ, S_{b} and S₃, S₄, Sₐ, S_{b}) into an AC voltage (U₆₈, U₉₈) associated with the respective load (L1, L2), wherein
two switching elements (Sₐ, S_{b}) are common to the bridge circuits (S₁, S₂, Sₐ, S_{b} and S₃, S₄, Sₐ, S_{b}).

2. A voltage converter as claimed in claim 1, which comprises a resonance converter (A3, A4) with a resonant series-parallel oscillation circuit for a load (L1, L2).

3. A voltage converter as claimed in claim 1, characterized in that the voltage converter comprises a control circuit (A5) for controlling the switching elements (S₁, S₂, Sₐ, S_{b}, S₃, S₄) of the bridge circuits (S₁, S₂, Sₐ, S_{b} and S₃, S₄, Sₐ, S_{b}), for which a first mode is provided in which the bridge circuits are operated as half bridge circuits through a change in the switching states of the respective non-shared first and second switching elements (S₁, S₂ and S₃, S₄), and the switching states of the shared third and fourth switching elements (Sₐ, S_{b}) are not changed, and in which a second mode is provided in which the bridge circuits are operated as full bridge circuits through a change in the switching states of all four respective switching elements (S₁, S₂, Sₐ, S_{b} and S₃, S₄, Sₐ, S_{b}).

4. A voltage converter as claimed in claim 3, characterized in that the voltage converter is designed such that two different voltage levels (Uᵢₙ) can be applied to its input, as desired, and in that the control circuit (A5) provides an automatic switch-over between the two modes of the bridge circuits (S₁, S₂, Sₐ, S_{b} and S₃, S₄, Sₐ, S_{b}) in dependence on the applied input voltage (Uᵢₙ) such that the bridge circuits (S₁, S₂, Sₐ, S_{b} and S₃, S₄, Sₐ, S_{b}) are operated as full bridge circuits in the second mode in the case of a low input voltage (Uᵢₙ), whereas they are operated as half bridge circuits in the first mode in the case of a high input voltage (Uᵢₙ).

5. A voltage converter as claimed in claim 3, characterized in that the control circuit (A5) is designed for achieving an adaptation of the switching frequencies and/or the duty cycles of the switching elements (S₁, S₂, S₃, S₄, Sₐ, S_{b}) of the bridge circuits (S₁, S₂, Sₐ, S_{b} and S₃, S₄, Sₐ, S_{b}).

6. A voltage converter as claimed in claim 3, characterized in that the control circuit (A5) is designed for operating the switching elements (S₁, S₂, S₃, S₄, Sₐ, S_{b}) of the bridge circuits (S₁, S₂, Sₐ, S_{b} and S₃, S₄, Sₐ, S_{b}) with an identical switching frequency.

7. A voltage converter as claimed in claim 3, characterized in that the control circuit (A5) is designed for modulating the switching frequencies and/or duty cycles of the switching elements (S₁, S₂, S₃, S₄, Sₐ, S_{b}) of the bridge circuits (S₁, S₂, Sₐ, S_{b} and S₃, S₄, Sₐ, S_{b}) with double the frequency of a first AC voltage (Uᵢₙ) applied to the input of the voltage converter.

8. An integrated circuit with at least a control circuit (A5) for the switching elements (S₁, S₂, S₃, S₄, Sₐ, S_{b}) of a voltage converter as claimed in claim 1.

9. A monitor with a voltage converter as claimed in claim 1.

10. A TV apparatus, for example with a flat picture screen, comprising a voltage converter as claimed in claim 1.
